(19) United States
(12) Patent Application Publication
(10) Pub. No.: US 2007/0247732 A1
(43) Pub. Date: Oct. 25, 2007

(54) Positinoing ring for combining convex mirror and back board

(76) Inventor: Yi Cyuan Shih, Changhua County (TW)

Correspondence Address: Yi Cyuan Shih, P.O. Box 44 - 2049, Taipei, 10668, TW

(21) Appl. No.: 11/409,012

(22) Filed: Apr. 24, 2006

(51) Int. Cl. G02B 7/182

(52) U.S. Cl. 359/879; 359/871

(57) ABSTRACT

A convex mirror assembly includes convex mirror and a back board, wherein each of the convex mirror and the rear box has a bent portion and a positioning ring encloses the bent portions. The positioning ring is composed of a plurality of sections and each section has a substantially C-shaped cross section which has an enclosing portion, a covering portion and a support potion extending transversely from a first end and a second end of the enclosing portion. Two respective distal ends of the bent peripheries are in contact with the support portion. The covering portion has an overlapping portion on a first end thereof and an engaging portion on a second end thereof, so that the overlapping portion of a first section is sized to overlap on the engaging portion of a second section next to the first section.

### FIELD OF THE INVENTION

The present invention relates to a combination of a convex mirror and a back board, and more particularly, to a positioning ring to conveniently combine the convex mirror and back board.

### BACKGROUND OF THE INVENTION

A conventional convex mirror assembly is used for providing images of the coming vehicles on a curved rod and the convex mirror assembly generally includes a convex mirror and a metal board which is located at a rear side of the convex mirror and a positioning ring is used to combine the convex mirror and the metal board. The positioning ring is a C-shaped rubber member and has a C-shaped cross section so that the convex mirror and the metal board are enclosed by the positioning ring. Screws extend through the positioning ring, the convex mirror and the metal board. The two separated distal ends of the rubber member are then connected to each other by way of heat or gluing. However, the rubber member tends to be deformed and cannot secure the convex mirror and the metal board. The rubber member is also deformed by the screws which even deforms the curvature of the convex mirror.

The present invention intends to provide a convex mirror assembly wherein the positioning ring can be easily installed and decoration or reflection members can also be connected on the positioning ring.

### SUMMARY OF THE INVENTION

The present invention relates to a convex mirror assembly which comprises a positioning ring composed of a plurality of sections and each section has a substantially C-shaped cross section which has an enclosing, a covering portion and a support potion extending transversely from a first end and a second end of the enclosing portion. The covering portion has an overlapping portion on a first end thereof and an engaging portion on a second end thereof. The overlapping portion of a first section is sized to overlap on the engaging portion of a second section next to the first section. A convex mirror and a back board which is located behind the convex mirror. Each of the of the convex mirror and the back board has a bent periphery which is enclosed by the enclosing portion, and two respective distal ends of the bent peripheries are in contact with the support portion.

The primary object of the present invention is to provide a positioning ring for combining the convex mirror and the back board, the positioning ring is composed of sections which are easily and conveniently connected with each other.

Another object of the present invention is to provide a positioning ring on which decoration members are connected.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a perspective view of a section of the positioning ring of the present invention;

FIG. 2 shows the connection of two adjacent sections of the present invention;

FIG. 3 is a perspective view of the positioning ring;

FIG. 4 shows a cross section of the convex mirror and the back board;

FIG. 5 shows the bent peripheries of the convex mirror and the back board are covered by the enclosing portion, and two distal ends of the bent peripheries are in contact with the flat surface of the support portion;

FIG. 6 shows the bent peripheries of the convex mirror and the back board are covered by the enclosing portion, and two distal ends of the bent peripheries are engaged with the groove of the support portion;

FIG. 7 shows that decoration members are engaged with apertures of the sections of the positioning ring;

FIG. 8 is an exploded view to show the decoration members and the section the with apertures;

FIG. 9 is a cross sectional view to show the engagement between the decoration members and the apertures in FIG. 8;

FIG. 10 shows the decoration members are engaged with the recesses in the sections of the positioning ring;

FIG. 11 is an exploded view to show the decoration members and the section with recesses;

FIG. 12 shows the positioning ring of the present invention as disclosed in FIG. 11;

FIG. 13 is a cross sectional view to show the engagement between the decoration members and the sections in FIG. 10;

FIG. 14 shows that positioning ring with illumination members connected thereto, and

FIG. 15 is a cross sectional view to show the illumination member is engaged with the hole in the back board.

### DETAILED DESCRIPTION OF THE PREFERRED EMBODIMENT

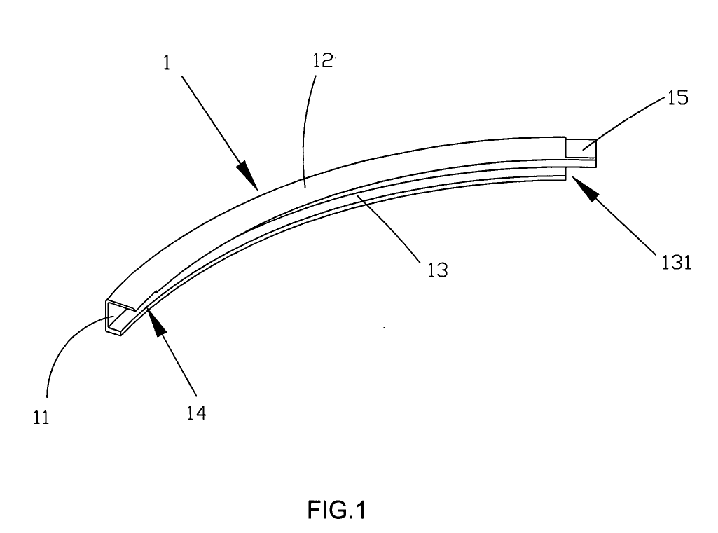

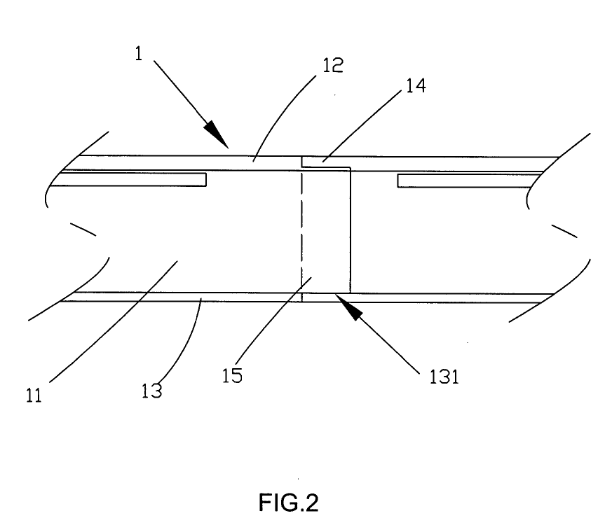

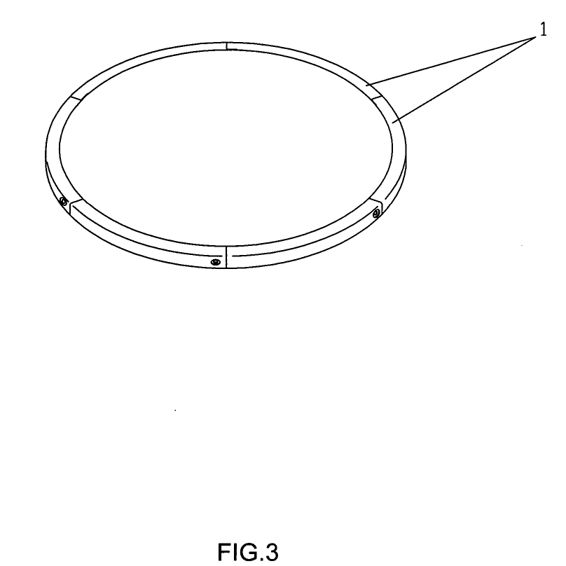

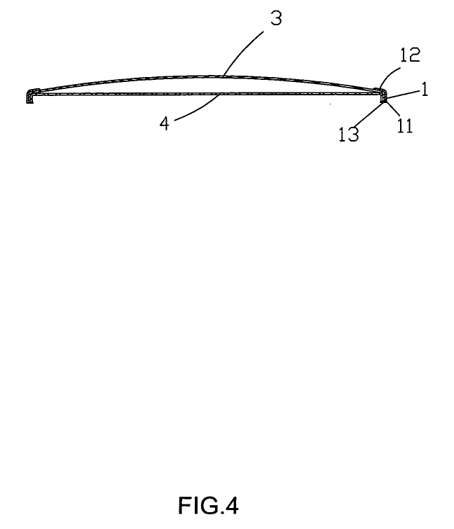

Referring to FIGS. 1 to 4, the convex mirror assembly of the present invention comprises a convex mirror 3 and a back board 4 which is located on the flat side of the convex mirror 3, a positioning ring encloses two respective peripheries of the convex mirror 3 and the back board 4.

The positioning ring is composed of a plurality of sections 1 and each section 1 has a substantially C-shaped cross section which has an enclosing portion 11, a covering portion 12 and a support portion 13 extending transversely from a first end and a second end of the enclosing portion 11. The covering portion 12 has an overlapping portion 14 on a first end thereof and an engaging portion 15 on a second end thereof, so that the overlapping portion 14 of a first section 1 is sized to overlap on the engaging portion 15 of a second section 1 next to the first section 1. The support portion 13 of each section 1 has a first end with a notch 131 defined therein and a second end, the second end of the support portion 13 of the first section 1 is engaged with the notch 131 of the second section 1 next to the first section 1.

Each of the of the convex mirror 3 and the back board 4 has a bent periphery 31/41 which is enclosed by the enclosing portion 11, and two respective distal ends of the bent peripheries 31, 41 are in contact with the support portion 13.

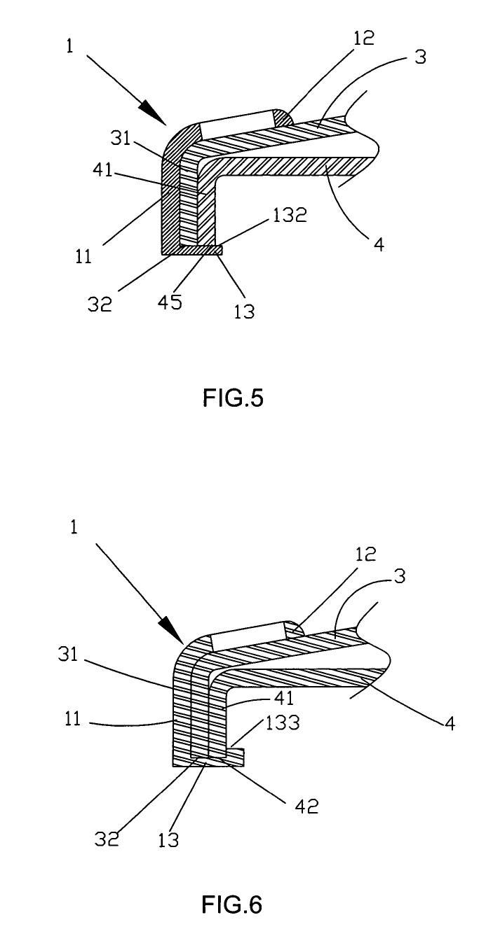

As shown in FIG. 5, the support portion 13 has a flat surface 132 defined in an inside thereof and the two respective distal ends of the bent peripheries 31, 41 are in contact with the flat surface 132 of the support portion 13. Alternatively, as disclosed in FIG. 6, the support portion 13 may have a groove 133 defined in an inside thereof and the two respective distal ends of the bent peripheries 31, 41 are engaged with the groove 133 of the support portion 13.

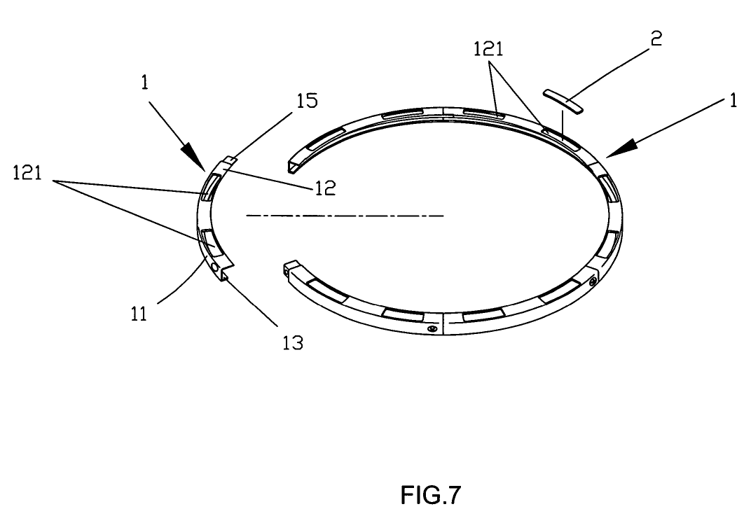

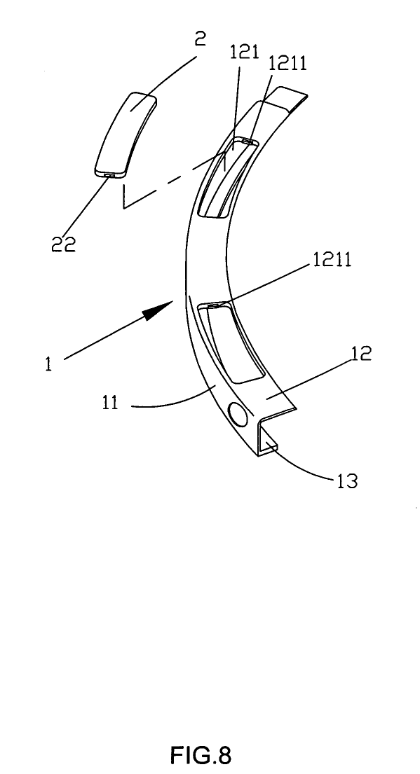

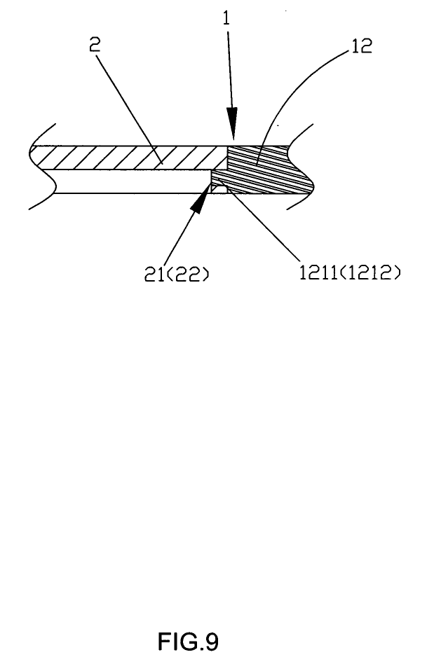

As shown in FIGS. 7 to 9, a second embodiment of the present invention is disclosed, wherein the covering portion 12 of each section 1 has a plurality of apertures 121 defined therethrough and each aperture 121 includes first positioning members 1211, 1212 such as protrusions extending from an inner periphery of the aperture 121. A plurality of decoration members 2 are engaged with the apertures 121 and each decoration member 2 has second positioning members 21, 22 such as dents which are engaged with the first positioning members 1211, 1212. The decoration members 2 may have a reflective surface so that light can be reflected by the decoration members 2.

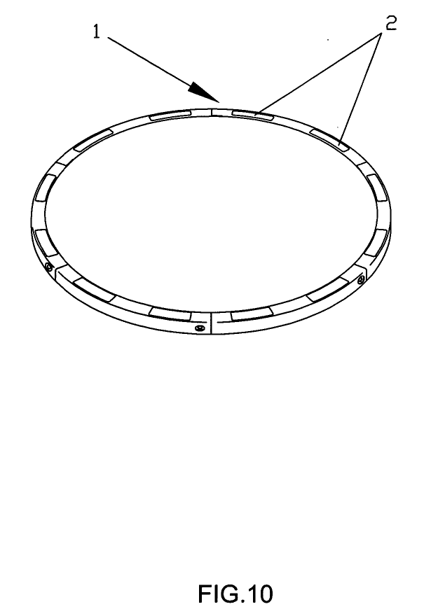

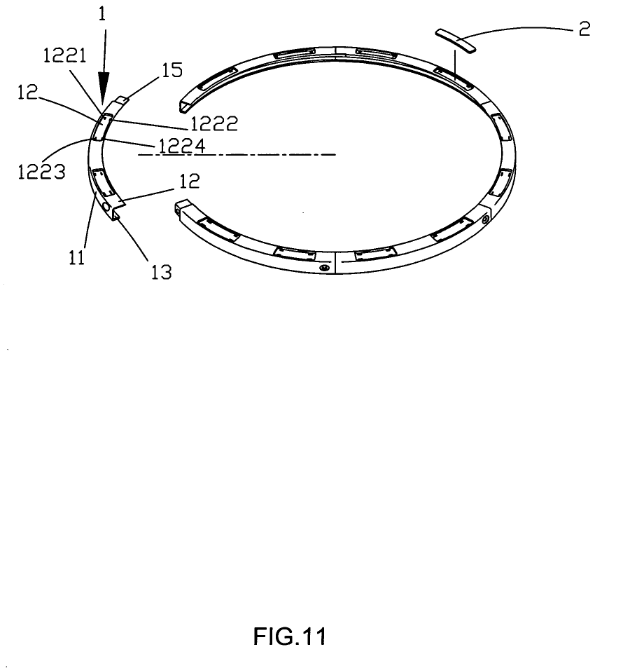

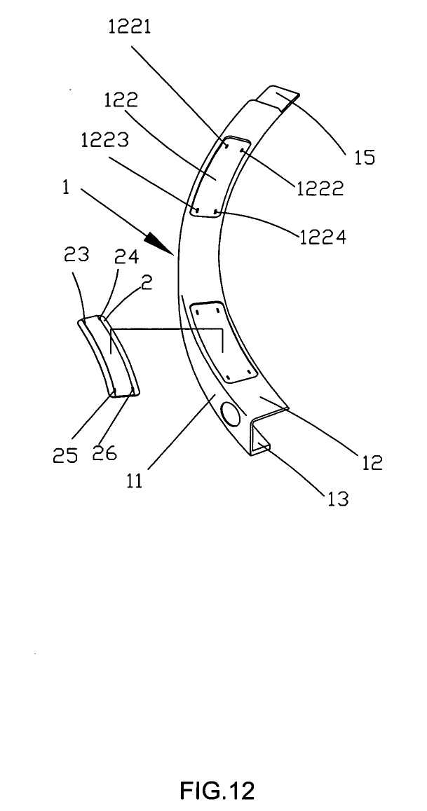

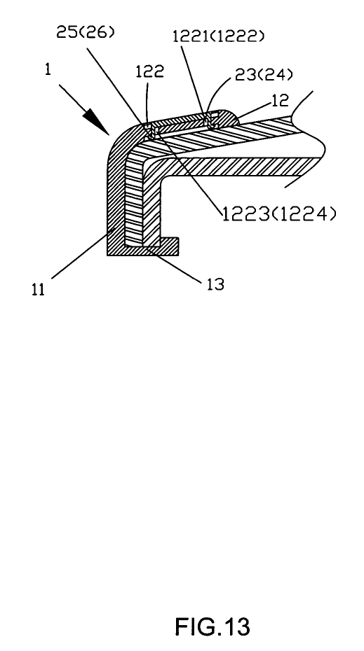

FIGS. 10 to 12 show yet another embodiment of the present invention, wherein the covering portion 12 of each section 1 has a plurality of recesses 122 defined therein and each recess 122 includes third positioning members 1221, 1222, 1223, 1224 such as engaging notches. A plurality of decoration members 2 are engaged with the recesses 122 and each decoration member 2 has fourth positioning members 23, 24, 25, 26 such as positioning extensions extending from an underside thereof. The positioning extensions are engaged with the third positioning members 1221, 1222, 1223, 1224.

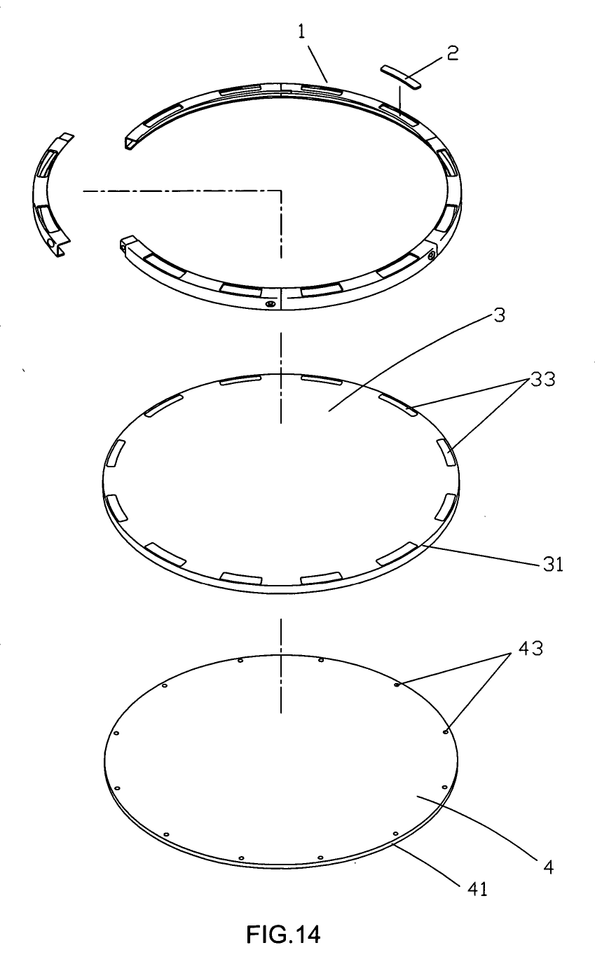

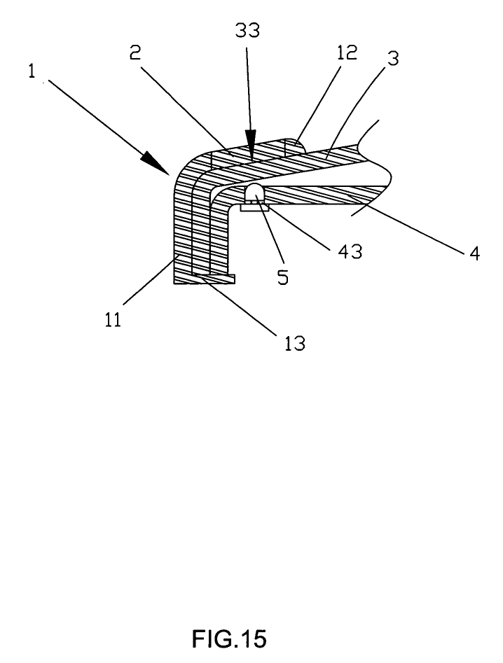

FIGS. 14 and 15 shows a further embodiment of the present invention, wherein the covering portion 12 of each section 1 has a plurality of apertures 121 defined therethrough and the convex mirror 3 includes a plurality of transparent windows 33 which are located in alignment with the apertures 121. The back board 4 includes a plurality holes 43 which are located in alignment with the transparent windows 33 and each hole 43 has an illumination member 5 engaged therewith. The decoration members 2 are transparent plates so that the light beams generated from the illumination members 5 can be seen via the transparent windows 33 and the transparent decoration members 2.

While we have shown and described the embodiment in accordance with the present invention, it should be clear to those skilled in the art that further embodiments may be made without departing from the scope of the present invention.

What is claimed is:

1. A convex mirror assembly comprising:
a positioning ring composed of a plurality of sections and each section having a substantially C-shaped cross section which has an enclosing portion, a covering portion and a support potion extending transversely from a first end and a second end of the enclosing portion, the covering portion having an overlapping portion on a first end thereof and an engaging portion on a second end thereof, the overlapping portion of a first section being sized to overlap on the engaging portion of a second section next to the first section, and
a convex mirror and a back board located behind the convex mirror, each of the of the convex mirror and the back board having a bent periphery which is enclosed by the enclosing portion, two respective distal ends of the bent peripheries are in contact with the support portion.

2. The assembly as claimed in claim 1, wherein the support portion of each section has a first end with a notch defined therein and a second end, the second end of the support portion of the first section is engaged with the notch of the second section next to the first section.

3. The assembly as claimed in claim 1, wherein the support has a flat surface defined in an inside thereof and the two respective distal ends of the bent peripheries are in contact with the flat surface of the support portion.

4. The assembly as claimed in claim 1, wherein the support has a groove defined in an inside thereof and the two respective distal ends of the bent peripheries are engaged with the groove of the support portion.

5. The assembly as claimed in claim 1, wherein the covering portion of each section has a plurality of apertures defined therethrough and each aperture includes first positioning members, a plurality of decoration members are engaged with the apertures and each decoration member has second positioning members which are engaged with the first positioning members.

6. The assembly device as claimed in claim 5, wherein the first positioning members are protrusions extending from an inner periphery of the aperture and the second positioning members are dents with which the protrusions are engaged.

7. The assembly as claimed in claim 1, wherein the covering portion of each section has a plurality of recesses defined therein and each recess includes third positioning members, a plurality of decoration members are engaged with the recesses and each decoration member has fourth positioning members which are engaged with the third positioning members.

8. The assembly as claimed in claim 5, wherein the decoration members are transparent.

9. The assembly as claimed in claim 1, wherein the covering portion of each section has a plurality of apertures defined therethrough and the convex mirror includes a plurality of transparent windows which are located in alignment with the apertures, the back board includes a plurality holes which are located in alignment with the transparent windows and each hole has an illumination member engaged therewith.
